(19) United States
(12) Patent Application Publication
(10) Pub. No.: US 2012/0272495 A1
(43) Pub. Date: Nov. 1, 2012

(54) Fence Repair System And Method Of Use

(76) Inventors: Leroy Hildebrandt, Tilden, TX (US); Hugh Mcclaugherty, Tilden, TX (US)

(21) Appl. No.: 13/097,527

(22) Filed: Apr. 29, 2011

(51) Int. Cl. B23P 6/00; F16B 33/00

(52) U.S. Cl. 29/402.01; 411/368

(57) ABSTRACT

A fence repair system comprising a bolt, where the bolt includes a head and a threaded end; a flat bar fastened on the bolt by the head; a washer fastened on the bolt near the threaded end; a nut threaded onto the threaded end wherein the nut secures the flat bar against a misaligned panel while the bolt is attached to an anchor panel of a fence. For use, a hole is drilled into the anchor panel. The bolt slides through the flat bar and then the bolt slides through the hole in the anchor panel. The nut is screwed onto the threaded end until the nut presses against the anchor panel. Once the fence repair system is in place the misaligned panel is secured next to the anchor panel by the flat bar. The system is held in place with the bolt and nut within the anchor panel.

### BACKGROUND OF THE INVENTION

1. Field of the Invention

The present invention relates to a fence repair system wherein a flat bar anchors a misaligned fence panel against an aligned fence panel or fence post to secure the misaligned panel back in place.

2. Description of Related Art

Most privacy fences are built with 4×4 and 2×4 planks of wood. Their primary purpose is to prevent outsiders from seeing onto the property enclosed by the fence. The fences are commonly used to distinguish the boarders between properties especially in residential areas. Over time some of the panels may become slanted or loose causing them to tilt away from the rest of the panels. These slanted panels defeat the purpose of the privacy fence by allowing gaps where outsiders may easily see onto the inner property. Often when a panel comes out of line the user must remove the damaged panel and replace it with a new one. If too many panels are damaged then an entire section of fence must be replaced.

Some developments have been made to assist a user to repair their fence. For example, U.S. Pat. No. 3,683,739 by George W. Garretson discloses fence repair system wherein a repair assembly assists a fence post to support horizontally attached fence members. While this system does assist in fence repair it does not apply to use with privacy fences. Alternatively, U.S. Patent Application No. 2011/0012077 by Tony Ramsey discloses a device for eliminating fence gate sagging wherein a bracket is attached to a support beam behind a sagging fence panel. A hook at the end of an elongated bar attached to the bracket, engages the sagging panel to place it back in alignment. While this device is used with a privacy fence it may be large and awkward to manipulate causing greater hassle for the user. Therefore, it would be desirable in the art to provide a fence repair kit that allows a user to easily repair their misaligned fence panels without requiring assembly of large repair pieces.

### SUMMARY OF THE INVENTION

In view of the foregoing disadvantages inherent in the prior art, the purpose of the present disclosure is to provide a fence repair system wherein a flat bar anchors a misaligned fence panel against an aligned fence panel or fence post to secure the misaligned panel back in place.

To achieve the above purpose, in an aspect of the present invention, a fence repair system is disclosed comprising a bolt, where the bolt includes a head and a threaded end; a flat bar fastened on the bolt by the head; a washer fastened on the bolt near the threaded end; a nut threaded onto the threaded end wherein the nut secures the flat bar against a misaligned panel while the bolt is attached to an anchor panel of a fence. For use, a hole is drilled into the anchor panel. The bolt slides through the flat bar and then the bolt slides through the hole in the anchor panel. The nut is screwed onto the threaded end until the nut presses against the anchor panel. Once the fence repair system is in place the misaligned panel is secured next to the anchor panel by the flat bar. The system is held in place with the bolt and nut within the anchor panel.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a fence repair system as individual pieces in accordance with an exemplary embodiment of the present invention;

FIG. 2 depicts a perspective view of a fence repair system with the pieces attached in accordance with an exemplary embodiment of the present invention; and

FIG. 3 depicts a perspective view of a fence repair system on a fence in accordance with an exemplary embodiment of the present invention.

Like reference numerals refer to like parts throughout the description of several views of the drawings.

### DETAILED DESCRIPTION OF THE DRAWINGS

The present invention relates to a fence repair system wherein a flat bar anchors a misaligned fence panel against an aligned fence panel or fence post to secure the misaligned panel back in place. The fence repair system essentially includes a bolt, a flat bar, a washer and a nut to restore and extend the life of a privacy fence. The fence repair system provides a simple and affordable method of mending wobbly, loose and disoriented fence panels.

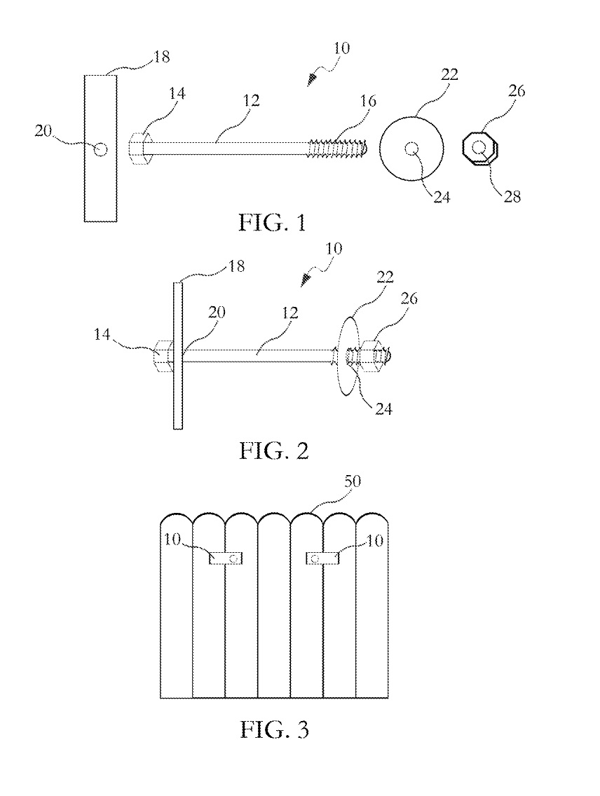

Turning now descriptively to the drawings, referring to FIG. 1, a perspective view of a fence repair system (10) as individual pieces is shown in accordance with an exemplary embodiment of the present invention. The fence repair system (10) includes a bolt (12), a flat bar (18), a washer (22) and a nut (26). The bolt (12) includes a head (14) and a threaded end (16) at opposing portions of the bolt (12). The head (14) and the nut (26) may comprise a hexagonal shape for use with conventional wrenches and drill bits. Alternatively, the head (14) may be a button, round or flat head depending on the likes and preferences of a user. Within a central portion of the flat bar (18) and the washer (22) are holes (20, 24). Also within a central portion of the nut (26) is a threaded hole (28). All of the pieces may be made from metal alloys or construction grade plastics to ensure durable and cost effective use.

Referring now to FIG. 2, a perspective view of the fence repair system (10) with the pieces attached is shown in accordance with an exemplary embodiment of the present invention. The hole (20) within the flat bar (18) accepts the threaded end (16) of the bolt (12). The bolt (12) slides through the hole (20) until the head (14) meets the flat bar (18) and prevents the bolt (12) from sliding all the way through the flat bar (18). Next, the washer (22) is attached to the bolt (12) by sliding the threaded end (16) through the hole (24). The threaded end (16) is constructed to fasten into the threaded hole (28) utilizing complementary threads as the nut (26) is screwed onto the threaded end (16) until a desired tightness is reached.

Referring to FIG. 3, a perspective view of the fence repair system (10) is shown on a fence (50) in accordance with an exemplary embodiment of the present invention. The fence (50) includes a plurality of panels (52) or boards fastened next to each other in a line. Some of the panels (52) are attached to posts that are anchored into the ground. Many times one or more of the panels (52) may become slanted, wobbly, loose, or disoriented resulting in a misaligned panel (56). The fence repair system (10) attaches to an anchor panel (54) which is the panel next to the misaligned panel (56). The anchor panel (54) may be attached to a post for greater structural stability. During use the fence repair system (10) pulls the misaligned panel (56) against the anchor panel (54) to align the misaligned panel (56) with the rest of the fence (50). The fence repair system (10) serves as a vice-like correction tool to pull the misaligned panel (56) back in place.

To describe the operation of the fence repair system (10) all figures may be referenced. During use, first the user may straighten the misaligned panel (56) by clamping the misaligned panel (56) against the anchor panel (54) or another proximal panel (52). Next, the user drills a hole into the anchor panel (54) using a drill bit with the same diameter as the bolt (12). If the anchor panel (54) is attached to a post then the user must also drill through the post along with the anchor panel (54). If the post is drilled, then an elongated bolt may be used to ensure that the threaded end (16) reaches all the way through the anchor panel (54) and the post.

To prepare the fence repair system (10), the flat bar (18) first slides onto the bolt (12) until the flat bar (18) reaches the head (14). Then the bolt (12), threaded end (16) first, is slid through the fence hole in the anchor panel (54) until the flat bar (18) meets the misaligned panel (56) and the anchor panel (54). The washer (22) then slides onto the threaded end (16) until it meets the backside of the anchor panel (54). The nut (26) is then screwed onto the threaded end (16) until the washer (22) and the nut (26) are pressed tight against the anchor panel (54). For additional torque a wrench may be used to securely tighten the nut (22) in place. Once the fence repair system (10) is in place the misaligned panel (56) is secured next to the anchor panel (54) by the flat bar (18). Finally, the clamp is removed leaving the fence (50) in proper alignment.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A fence repair system comprising:
a bolt, where said bolt includes a head and a threaded end;
a flat bar fastened on said bolt by said head;
a washer fastened on said bolt near said threaded end;
a nut threaded onto said threaded end wherein said nut secures said flat bar against a misaligned panel while said bolt is attached to an anchor panel of a fence.

2. The fence repair system according to claim 1, wherein said bolt is an elongated bolt to enable said elongated bolt to pass through a fence post.

3. The fence repair system according to claim 1, wherein said head comprises a button head.

4. The fence repair system according to claim 1, wherein said head comprises a round head.

5. The fence repair system according to claim 1, wherein said head comprises a flat head.

6. The fence repair system according to claim 1, wherein said bolt, said flat bar, said washer and said nut are comprised of a metal alloy.

7. The fence repair system according to claim 1, wherein said bolt, said flat bar, said washer and said nut are comprised of a construction grade plastic.

8. The method of use for a fence repair system comprising the steps of:
drilling a hole into an anchor panel next to said misaligned panel;
threading a bolt through a flat bar;
sliding said bolt through said hole until said flat bar touches said misaligned panel;
threading a washer onto a threaded end of said bolt; and
screwing a nut onto said threaded end until said washer and said nut are pressed tight against said anchor panel resulting in said misaligned panel secured in place with said flat bar next to said anchor panel.

9. The method of use for the fence repair system according to claim 8 further comprising the step of clamping said misaligned panel to a proximal panel before sliding said bolt through said hole.

10. The method of use for the fence repair system according to claim 9, further comprising the step of unclamping said misaligned panel.
